(19) United States
(12) Patent Application Publication
(10) Pub. No.: US 2006/0189376 A1
(43) Pub. Date: Aug. 24, 2006

(54) Wagering game with enhancement feature for allowing additional wager during performance of the wagering game

(75) Inventors: Jeremy Hornik, Chicago, IL (US); Dion Aoki, Henderson, NV (US); Joel R. Jaffe, Glenview, IL (US); James Poole, Buckinghamshire (GB); Allon Englman, Chicago, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(73) Assignee: WMS Gaming, Inc.

(21) Appl. No.: 11/335,932

(22) Filed: Jan. 20, 2006

Related U.S. Application Data
(60) Provisional application No. 60/648,650, filed on Jan. 31, 2005.

(51) Int. Cl. A63F 13/00

(52) U.S. Cl. 463/20

(57) ABSTRACT

A gaming terminal is utilized for playing a wagering game. The gaming terminal includes a wager-input device and a display for displaying a plurality of moveable reels having symbols located thereon during the wagering game. The symbols indicate a randomly-selected outcome selected from a plurality of outcomes. After at least a first one of the moveable reels has started spinning, an opportunity to make an additional wager via the wager-input device is presented while at least one of the moveable reels is still spinning. The additional wager allows for an enhancement of an outcome after all of the moveable reels have stopped spinning.

### CROSS-REFERENCE TO RELATED APPLICATIONS

This application claims the benefit of priority of U.S. Provisional Patent Application No. 60/648,650, filed Jan. 31, 2005, which is hereby incorporated by reference in its entirety.

### FIELD OF THE INVENTION

The present invention relates generally to gaming terminals for playing a wagering game and, more particularly, to a gaming terminal having a plurality of movable symbol-bearing reels and having a feature for providing an opportunity to make an additional wager during the wagering game to provide enhanced outcomes.

### BACKGROUND OF THE INVENTION

Gaming terminals, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming terminal industry, there is a continuing need for gaming terminal manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming terminal without winning the jackpot. Further, when several gaming terminals are linked together such that several players at several gaming terminals compete for the same jackpot, the jackpot progressively increases at a much faster rate, which leads to further player excitement.

In current basic games, the player is usually given a single opportunity to wager on the basic game. For example, the player typically has to make the wager prior to initiation of the basic game. However, in the event that the player achieves a good result part of the way through the basic game, the player has no way of increasing the original wager to achieve an enhanced outcome. That is, the player has no way of modifying the wager during the basic game even though the player realizes that a winning combination is going to be achieved halfway through the basic game. Accordingly, in the event that the player continues to fail to win credits or a bonus, the player may become bored and move on to a different game.

Thus, there is a need to provide a player with an opportunity to make an additional wager during the basic game, to increase the potential payout for a winning outcome. This way, when the player achieves good results at the start of the basic game, the player can wager additional credits in an attempt to achieve enhanced outcomes. Wagering games need to include additional features like this to maintain the player's interest and enhance entertainment. The present invention is directed to satisfying this and other needs.

### SUMMARY OF THE INVENTION

The present invention is directed to a gaming terminal for playing a wagering game. The gaming terminal includes a wager-input device and a display for displaying a plurality of moveable reels having symbols located thereon during the wagering game. The symbols indicate a randomly-selected outcome selected from a plurality of outcomes. After a at least one of the moveable reels has started spinning, an opportunity to make an additional wager via the wager-input device is presented while at least one of the moveable reels is still spinning. The additional wager allows for an enhancement of an outcome after all of the moveable reels have stopped spinning.

The present invention is further directed to a method of conducting a wagering game. A wager is received from a player, and a game outcome is randomly selected from a plurality of outcomes in response to the wager. The game outcome is displayed as symbols on a plurality of symbol-bearing reels in alignment along at least one payline. An opportunity to make an additional wager is presented while at least one of the symbol-bearing reels is still moving. A payout for a winning combination of the symbol-bearing reels is increased, in response to receipt of the additional wager, when the winning combination includes a symbol located on at least one of the symbol-bearing reels that was moving when the opportunity was presented.

The present invention is further directed to a gaming terminal for playing a wagering game. The gaming terminal includes at least one display and a controller coupled to the display. The controller is programmed to (a) move symbols on a plurality of moveable reels across the display to indicate an outcome of a plurality of outcomes, (b) present an opportunity to make a secondary wager after at least one of the moveable reels has started spinning and while at least one of the moveable reels is still spinning, and (c) in response to receipt of the secondary wager, increase a payout for a winning combination of the moveable reels, in response to receipt of the additional wager, when the winning combination includes a symbol located on at least one of the moveable reels that was moving when the opportunity was presented.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a video gaming terminal according to one embodiment of the present invention.

FIG. 2 is a block diagram of the gaming terminal of FIG. 1.

FIGS. 3 and 4 illustrate the gaming terminal adapted to allow an additional wager during the wagering game according to an embodiment of the invention.

FIGS. 5 and 6 illustrate an alternative embodiment of the wagering game in which the player is given the opportunity to make an additional wager after the first three reels have stopped spinning, but the last two reels are still spinning.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

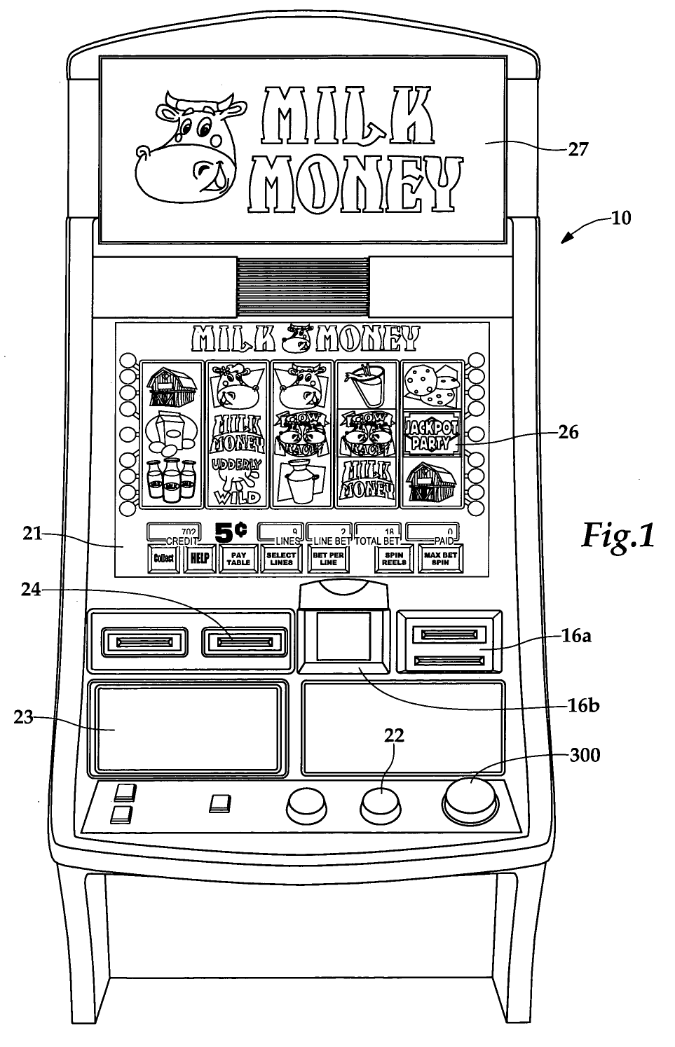

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as well.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

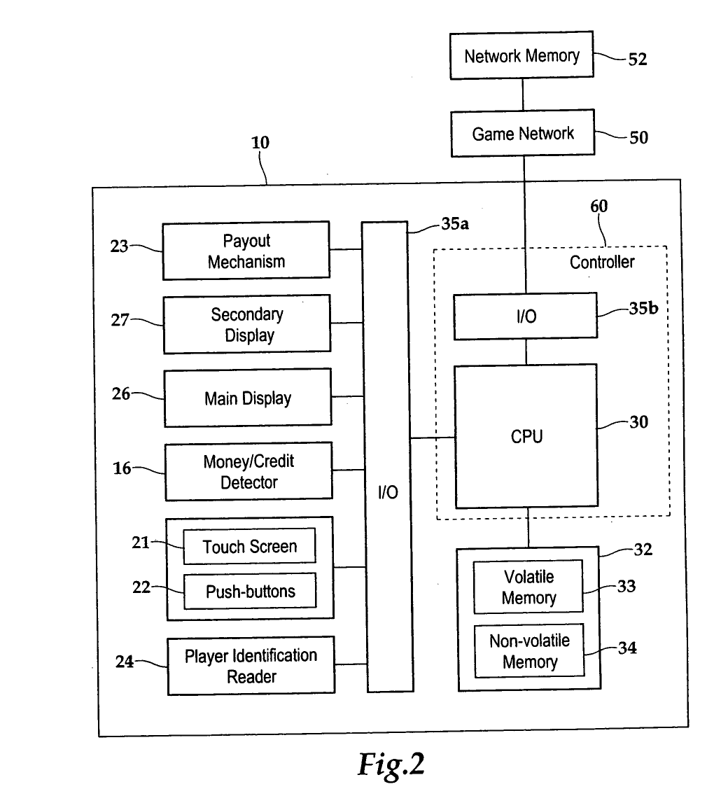

As shown FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

In some embodiments, the CPU 30 may not be inside the gaming terminal 10. Instead, the CPU 30 may be part of a game network 50 (FIG. 2) and may be used to control numerous gaming terminals 10. In these embodiments, the CPU 30 will run the basic games for each of the gaming terminals 10, and may also be used to link the gaming terminals 10 together. The game network 50 can include progressive jackpots that are contributed to by all or some of the gaming terminals 10 in the network (e.g., terminal-level jackpots that only each terminal 10 contributes to, bank-level jackpots that are contributed to by all of the terminals 10 in a particular bank, and wide-area jackpots that are contributed to by a larger number of terminals 10, such as multiple banks). Alternatively, the game network 50 can allow the player to retrieve assets obtained while playing one terminal 10 at a different gaming terminal that is also part of the game network. Assets may be any number of things, including, but not limited to, monetary or non-monetary awards, features that a player builds up in a bonus or progressive game to win awards, etc.

In some embodiments, the CPU 30 is also used with the information reader 24 to restore saved assets. For example, in one embodiment, the information reader 24 is adapted to receive and distribute tickets (see FIG. 4). The tickets each include a unique identifier. The unique identifier links the ticket to a file contained within the local memory 32 or a system memory 52 located in the game network 50. The file includes the assets that are being stored from a previous game. Monetary awards include game credits or money, while the non-monetary awards can be bonus tokens, free plays (e.g., free spins), multipliers, or access to bonus and/or progressive games. The player may also be awarded the option of selecting between receiving a certain value of standard credits or receiving bonus tokens that are redeemable for a special wagering event.

The gaming terminal 10 and associated gaming control system is capable of executing wagering games on or through a controller 60. Controller 60, as used herein, comprises any combination of hardware, software, and/or firmware that may be disposed or resident inside and/or outside of a gaming terminal 10 or like machine which may communicate with and/or control the transfer of data between the gaming terminal and a bus, another computer, processor, or device, and/or a service and/or a network. The network may include, but is not limited to a peer-to-peer, client/server, master/slave, star network, ring network, bus network, or other network architecture wherein at least one processing device (e.g., computer) is linked to at least one other processing device. The controller 60 may comprise the I/O circuits 35b and the CPU 30. In other embodiments, the CPU 30 may be housed outside of the controller 60, and a different processor may be housed within the controller 60. The controller 60, as used herein, may comprise one or more controllers. In one implementation, each gaming terminal 10 comprises, or is connected to, a controller 60 enabling each gaming terminal 10 to transmit and/or receive signals, preferably both, in a peer-to-peer arrangement. In another example, the controller 60 may be adapted to facilitate communication and/or data transfer for one or more gaming terminals 10 in a client/server or centralized arrangement. In one aspect, shown in FIG. 2, the controller 60 may connect the gaming terminal 10 via a conventional I/O port and communication path (e.g. serial, parallel, IR, RC, 10bT, etc.) to a game network 50, which may include, for example, other gaming terminals connected together in a network.

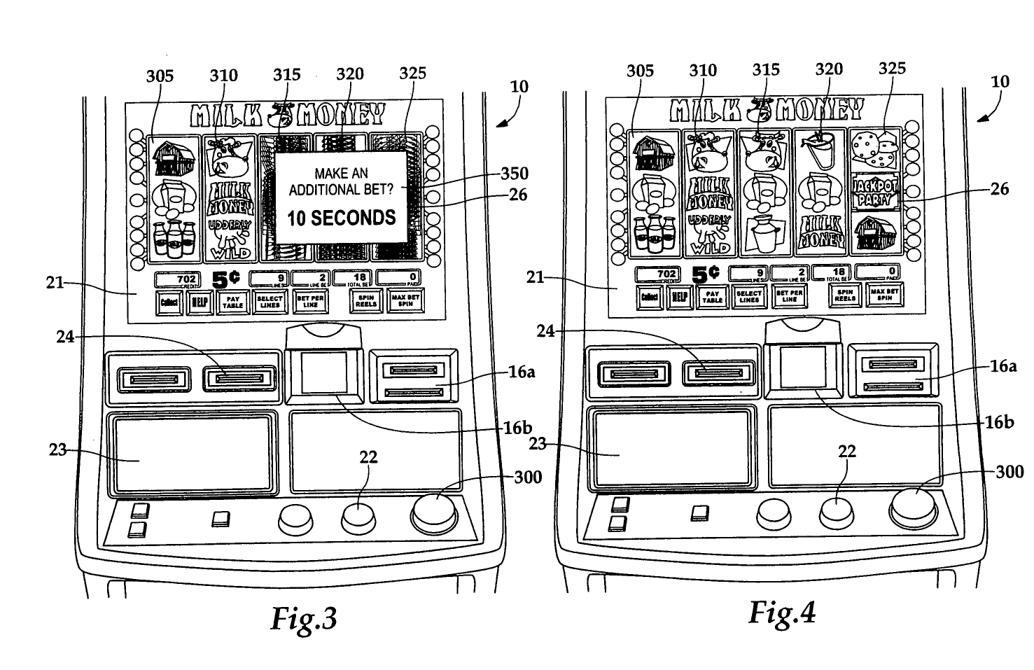

FIGS. 3 and 4 illustrate the gaming terminal 10 adapted to allow an additional wager during the wagering game according to an embodiment of the invention. As shown, the gaming terminal includes a wagering button 300. A corresponding wagering button may also be displayed on the touch screen 21. The player may make an additional wager during the middle of a slot game via use of the wagering button 300. For example, if the player achieves a good outcome on the first reels of the wagering game, the player may wager additional credits before the outcome of the remaining reels has been determined, resulting in excitement for the player and giving the player an additional incentive to continue playing the wagering game instead of moving to a different wagering game.

FIG. 3 illustrates the wagering game in which the player is given the opportunity to make an additional wager after the first two reels 305 and 310 have stopped spinning, but the last three reels 315, 320, and 325 of the five reels are still spinning. As shown, the second reel 305 displays a “wild” symbol (i.e., the “Udderly Wild” symbol) as the bottom visible symbol displayed to the player. In the event that the player sees this outcome after the first two reels 305 and 310 have stopped spinning, the player may decide that because a wild symbol is already showing, the player has a good chance of achieving a winning outcome. The player is presented with an opportunity to make an additional wager. This offer of the additional wager may be presented to the player by displaying the phrase “Make Additional Bet?” on a pop-up screen 350 and displaying a timer that counts down (for example, a countdown timer may be displayed to indicate that the player has 10 seconds to decide to make the additional wager). Alternatively, the countdown timer need not be displayed, and instead the remaining reels may spin until the player presses a predetermined button. The “Make Additional Bet?” phrase may be displayed in the pop-up screen 350 on top of the reels that are still spinning, above the top of the reels, or in any other suitable location on the touch screen 21, or even on a secondary display screen in some instances. When mechanical reels are utilized, this phrase may also be displayed via lights (e.g., LEDs) on the gaming terminal 10.

If the player decides not to make the additional wager, the game will continue as normal after the countdown timer has ended or by pressing a button to indicate that the offer is declined. However, the player may make the additional wager by either depressing the wagering button 300, pressing a button on the touch screen 21, or in any other suitable manner. By making the additional wager, the player enables various enhancements to outcomes of the wagering game. For example, in some embodiments, by making the additional wager, the player has the opportunity to be awarded a larger payout (e.g., more credits, extra free spins, etc.) upon achieving a winning combination of symbols on the reels when the reels have stopped spinning. In other embodiments, the additional wager changes the requirements for a winning combination. For example, if the standard wagering game requires a winning combination of symbols on the same payline, the additional wager may convert the remaining reels that are still spinning from a single payline to scatter, so that even though the beginning of the winning combination on the reels that had already stopped spinning when the additional wager was made must be on the same payline, the remaining symbols in the eventual winning combination that are on reels still spinning when the additional wager was made can be located on any visible location when those reels have stopped spinning.

FIG. 4 illustrates the outcome of the wagering game of FIG. 3. As shown, the player has achieved three of the “Milk and Eggs” symbols displayed on the middle of each of the reels 305, 310, 315, 320, and 325. In the event that the wagering game awards credits when three of the same symbols are located on the same payline, a winning outcome has been achieved. If the player had made the extra bet, the player would be awarded with an increased payout. If the player had not had the additional wager, then the payout would be the same as in the normal operation of the wagering game.

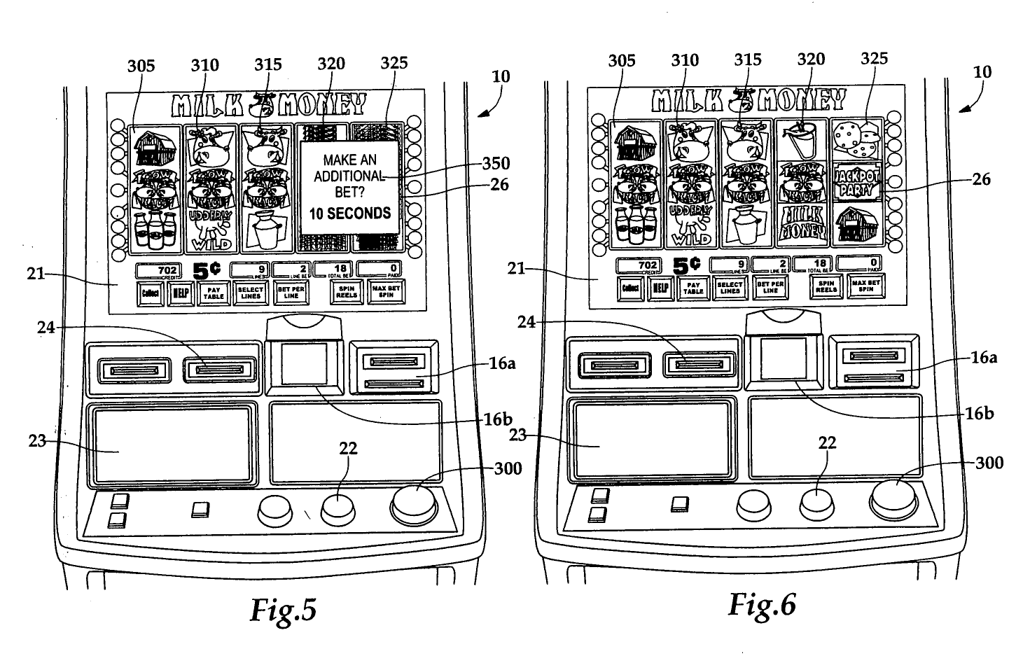

FIGS. 5 and 6 illustrate an alternative embodiment of the wagering game in which the player is given the opportunity to make an additional wager after the first three reels 305, 310, and 315 have stopped spinning, but the last two reels 320 and 325 of the five reels are still spinning. In the embodiment of FIGS. 5 and 6, the player is given the opportunity to make the additional wager after potentially viewing a winning combination on the first three stopped reels 305, 310, and 315. In the embodiment shown in FIGS. 5 and 6, the gaming terminal 10 may pay out upon either scatter or standard paylines.

As shown in FIG. 5, the first three reels all display the “Cow Race” symbol as the middle of the displayed symbols on these reels. Accordingly, if the player has bet on the payline for the middle symbols, the player would have already achieved a minimum combination for winning. By making an increased wager for the remaining reels 320 and 325 at this point, the player can play for substantially better payouts, as discussed above with respect to FIGS. 3 and 4. In some embodiments, the winning combination on the first three reels 305, 310, and 315 would be forfeited (either wholly or partially) in order to make the additional wager (e.g., the player would have to achieve a fourth “Cow Race” symbol to win anything), but in other embodiments, the player would simply have to wager additional credits. Also, in some embodiments where the player wagers additional credits, the player only achieves an increased payout over the regular payout if a symbol on the remaining two reels results in an improved winning combination over what was achieved on the first three reels alone.

FIG. 6 illustrates the results of the reels after the last two reels 320 and 325 have stopped spinning. As shown, the fourth reel 320 displays a “Cow Race” symbol, and a total of four consecutive “Cow Race” symbols are displayed as the middle symbols on the first four reels. In the event that the player had taken advantage of the opportunity to make the additional wager, the player would have been awarded a larger payout than would have been awarded under the ordinary payout if the additional wager had not been made.

Although the embodiment shown in FIGS. 5 and 6 is for a wagering game in which the opportunity to make the additional wager is only presented to the player after the first three reels have stopped spinning, in other embodiments, the player may be presented with two, or more, opportunities to make additional wagers. For example, the player may first be presented with an opportunity to make an additional wager after the first two reels 305 and 310 have stopped spinning, as described above with respect to FIGS. 3 and 4. However, after the third reel 315 has stopped spinning, the player may be given an additional opportunity to make the additional wager after the first three reels have stopped, as described with respect to FIGS. 5 and 6. Other embodiments may present the player with multiple opportunities to make additional wagers during the middle of the wagering game, even after only a single reel has stopped spinning.

The opportunity to make an additional wager during the wagering game makes the wagering game more attractive, exciting, and interactive for players. Because the players can selectively make the additional wager (e.g., only after relatively good symbol combinations are showing on a payline, such as a “Wild” symbol or multiple identical symbols), an element of skill comes into play, making the wagering game more enjoyable for the player.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A gaming terminal for playing a wagering game, comprising:
a display for displaying a plurality of moveable reels having symbols located thereon during the wagering game, the symbols indicating a randomly-selected outcome selected from a plurality of outcomes; and
a wager-input device, wherein after at least a first one of the moveable reels has started spinning, an opportunity to make an additional wager via the wager-input device is presented while at least one of the moveable reels is still spinning, the additional wager allowing for an enhancement of an outcome after all of the moveable reels have stopped spinning.

2. The gaming terminal of claim 1, wherein the opportunity is presented after at least a second one of the plurality of moveable reels has stopped spinning.

3. The gaming terminal of claim 2, wherein the additional wager is a forfeiture of a winning combination already visible on a second plurality of the moveable reels including the at least the second one of the plurality of moveable reels.

4. The gaming terminal of claim 1, wherein the additional wager is of additional credits.

5. The gaming terminal of claim 1, wherein the plurality of moveable reels include mechanical reels.

6. The gaming terminal of claim 1, wherein the display includes a glass panel that is located directly in front of the moveable reels.

7. The gaming terminal of claim 1, wherein the plurality of moveable reels include video reels.

8. The gaming terminal of claim 1, wherein the display includes at least one payline that traverses the plurality of moveable reels.

9. The gaming terminal of claim 8, wherein the enhancement includes modifying a requirement that a winning combination occur on the at least one payline, so that a second combination of
symbols located on the at least one payline for at least a second one of the moveable reels that were stopped when the additional wager was made, and
visible symbols located anywhere on the moveable reels that were spinning when the additional bet was made
results in the winning combination.

10. The gaming terminal of claim 1, wherein the enhancement includes increased payouts.

11. The gaming terminal of claim 1, wherein the enhancement includes increased payouts when winning combination occurs on an active payline.

12. A method of conducting a wagering game, the method comprising:
receiving a wager from a player;
randomly selecting a game outcome from a plurality of outcomes in response to the wager;
displaying the game outcome for the wagering game as symbols on a plurality of symbol-bearing reels in alignment along at least one payline;
presenting an opportunity to make an additional wager while at least one of the symbol-bearing reels is still moving; and
increasing a payout for a winning combination of the symbol-bearing reels, in response to receipt of the additional wager, when the winning combination includes a symbol located on at least one of the symbol-bearing reels that was moving when the opportunity was presented.

13. The method of claim 12, wherein the opportunity is presented after at least a second one of the symbol-bearing reels has stopped spinning.

14. The method of claim 12, further including displaying at least one payline that traverses the symbol-bearing reels.

15. The method of claim 14, wherein the additional wager modifies a requirement that a winning combination occur on the at least one payline, so that a second combination of
symbols located on the at least one payline for at least a second one of the symbol-bearing reels that were stopped when the additional wager was made, and
visible symbols located anywhere on the symbol-bearing reels that were spinning when the additional bet was made
results in the winning combination.

16. A gaming terminal for playing a wagering game, comprising:
at least one display; and
a controller coupled to the display and programmed to
move symbols on a plurality of moveable reels across the display to indicate an outcome of a plurality of outcomes,
present an opportunity to make a secondary wager after at least a first one of the moveable reels has started spinning and while at least one of the moveable reels is still spinning, and
in response to receipt of the secondary wager, increasing a payout for a winning combination of the moveable reels, in response to receipt of the additional wager, when the winning combination includes a symbol located on the at least one of the moveable reels that was spinning when the opportunity was presented.

17. The gaming terminal of claim 16, wherein the opportunity is presented after at least a second one of the plurality of moveable reels has stopped spinning.

18. The gaming terminal of claim 17, wherein the additional wager is a forfeiture of a winning combination already visible on a second plurality of the moveable reels including the at least the second one of the plurality of moveable reels.

19. The gaming terminal of claim 16, wherein the additional wager is of additional credits.

20. The gaming terminal of claim 16, wherein the controller is located within the gaming terminal.
